(19) United States
(12) Patent Application Publication
(10) Pub. No.: US 2012/0110403 A1
(43) Pub. Date: May 3, 2012

(54) Error Correction Scheme for Facsimile Over a Packet Switched Network

(76) Inventors: Ximing Chen, Ringoes, NJ (US); Herbert B. Cohen, Allentown, PA (US); Chengzhou Li, Bridgewater, NJ (US)

(21) Appl. No.: 12/917,635

(22) Filed: Nov. 2, 2010

(51) Int. Cl. H04L 1/18; G06F 11/14

(52) U.S. Cl. 714/748; 714/E11.113

(57) ABSTRACT

A method for correcting at least one error in a facsimile transmission over a packet switched communications network includes the steps of: detecting, by a first gateway coupled to the communications network, at least one missing data packet in a sequence of data packets transmitted from a second gateway coupled to the communications network during the facsimile transmission; transmitting, from the first gateway, a request for retransmission of the missing data packet to the second gateway; determining whether the missing data packet is available for retransmission; and, when the missing data packet is available, retransmitting the missing data packet to the first gateway.

### FIELD OF THE INVENTION

The present invention relates generally to the electrical, electronic, and computer arts, and more particularly relates to facsimile communications.

### BACKGROUND OF THE INVENTION

A traditional analog facsimile (or fax) generally involves the transmission of scanned-in printed material (e.g., text, photographs, or the like), usually to a telephone number associated with a printer or other output device via a public switched telephone network (PSTN), as specified, for example, in the International Telecommunication Union (ITU) T.30 standard (see, e.g., ITU-T Recommendation T30, Procedures for Document Facsimile Transmission in the General Switched Telephone Network, SERIES T: TERMINALS FOR TELEMATIC SERVICES, September 2005, the disclosure of which is incorporated by reference herein in its entirety for all purposes). The original source document is scanned in by the fax machine, which treats the contents as a single fixed graphic image, converting it to a bitmap. Once in this digital form, the information is transmitted as electrical signals through the telephone system. The receiving fax machine reconverts the coded image and prints a paper copy of the document.

Despite efforts to become a paperless society and regardless of the prevalence of email communications, fax transmission of printed materials (e.g., text or images) remains vital, particularly for business users. One reason for the continued popularity of faxes is that, unlike email attachments or digital signatures, the signature on a fax document is legally binding. Moreover, fax documents retain the format of the original source document and are virtually uneditable.

As the transmission of voice over the internet, using voice over internet protocol (VoIP) technology, permeates private and public organizations, such organizations have found it desirable to leverage the value and convenience of their single, distributed Internet Protocol (IP) communications network. Since fax transmissions generally utilize the same facilities as voice communications, it is becoming increasingly popular to implement traditional analog fax transmissions using facsimile over internet protocol (FoIP) as specified, for example, in the International Telecommunication Union (ITU) T.38 standard (see, e.g., ITU-T Recommendation T.38, Group 3 Protocols, Procedures for Real-time Group 3 Facsimile Communication Over IP Networks, SERIES T: TERMINALS FOR TELEMATIC SERVICES, FACSIMILE, April 2007, the disclosure of which is incorporated by reference herein in its entirety for all purposes).

The T.38 fax protocol supports the transmission of fax data across an IP network in real time, much like the original Group 3 (G3) fax standards did for the traditional PSTN. In this manner, T.38 preserves the traditional fax environment and yet allows faxes to be successfully sent and received by dynamically adjusting the transmitted fax signal to compensate for jitter, latency, and packet loss, which are common in the IP network. Without T.38, fax devices, which are sensitive to timing, would otherwise experience difficulty reliably sending and receiving faxes over an IP network. However, while the T.38 fax protocol addresses some of the problems associated with sending and receiving faxes in real-time over a packet network, several problems remain.

### SUMMARY OF THE INVENTION

The present invention, in illustrative embodiments thereof, provides an innovative error correction scheme for efficiently facilitating facsimile transmissions over a packet switched communications network. Techniques of the invention advantageously address problems associated with conventional error correction methodologies used for facsimile transmissions over packet switched communications networks.

In accordance with one embodiment of the invention, a method for correcting at least one error in a facsimile transmission over a packet switched communications network includes the steps of: detecting, by a first gateway coupled to the communications network, at least one missing data packet in a sequence of data packets transmitted from a second gateway coupled to the communications network during the facsimile transmission; transmitting, from the first gateway, a request for retransmission of the missing data packet(s) to the second gateway; determining whether the missing data packet(s) is(are) available for retransmission; and, when the missing data packet(s) is(are) available, retransmitting the missing data packet(s) to the first gateway.

In accordance with another embodiment of the invention, an apparatus for correcting at least one error in a facsimile transmission over a packet switched communications network includes at least a first gateway adapted for connection to the packet switched communications network. The first gateway includes at least one processor operative: (i) to detect at least one missing data packet in a sequence of data packets transmitted from a second gateway coupled to the communications network during the facsimile transmission; (ii) to transmit a request for retransmission of the missing data packet(s) to the second gateway; and (iii) to receive the missing data packet(s) retransmitted from the second gateway when the missing data packet(s) is(are) available for retransmission.

In accordance with yet another embodiment of the invention, an apparatus for correcting at least one error in a facsimile transmission over a packet switched communications network includes at least a first gateway adapted for connection to the packet switched communications network. The first gateway includes memory and at least one processor coupled to the memory. The processor is operative: (i) to transmit at least one facsimile data packet in a sequence of data packets to a second gateway coupled to the communications network during the facsimile transmission; (ii) to store, in the memory, a copy of the data packet; (iii) to receive a request for retransmission of at least one missing data packet, the request for retransmission being sent by the second gateway and identifying the missing data packet(s) in the sequence of data packets detected by the second gateway; and (iv) to retransmit the missing data packet(s) to the second gateway when the missing data packet(s) is(are) available in the memory for retransmission.

These and other features, objects and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals indicate corresponding elements throughout the several views, and wherein:

FIG. 1 is a block diagram depicting at least a portion of an illustrative dedicated IP-aware fax engine adapted for providing fax communications over an IP network;

FIG. 2 is a block diagram depicting a simple exemplary FoIP network in which principles of the present invention may be implemented;

FIG. 3 is a block diagram depicting at least a portion of an exemplary fax transmission stream in which fax packets are sent in varying time intervals;

FIG. 4 is a block diagram depicting at least a portion of exemplary fax transmission stream in which idle packets are inserted into the packet sequence such that each packet interval is not greater than a prescribed value, according to an embodiment of the present invention;

FIG. 5 depicts at least a portion of an illustrative data transfer between a transmit gateway and a receive gateway during a FoIP session, according to an embodiment of the present invention; and

FIG. 6 is a block diagram depicting an exemplary data processing system, according to an aspect of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present invention will be described herein in the context of illustrative embodiments of a packet recovery methodology and apparatus for ITU T.38-based FoIP. It is to be appreciated, however, that the invention is not limited to the specific apparatus and methods illustratively shown and described herein. Rather, aspects of the invention are directed broadly to techniques for efficiently correcting errors which may occur in a facsimile transmission over a packet switched communications network. In various embodiments, the innovative error correction scheme for facsimile over a packet switched network is implemented, for example, in a client computing device, a residential gateway, a network device and the like, to support facsimile over packet switched network services to remote facsimile machines. Techniques of the invention may be employed either alone or in conjunction with one or more existing error correction methodologies to thereby enhance such existing methods.

While illustrative embodiments of the invention will be described herein with reference to an ITU T.38 protocol, it is to be appreciated that the invention is not limited to use with this or any particular protocol(s). Rather, principles of the invention may be extended to essentially any facsimile communications protocol, both standard and non-standard. Moreover, it will become apparent to those skilled in the art given the teachings herein that numerous modifications can be made to the embodiments shown that are within the scope of the present invention. That is, no limitations with respect to the specific embodiments described herein are intended or should be inferred.

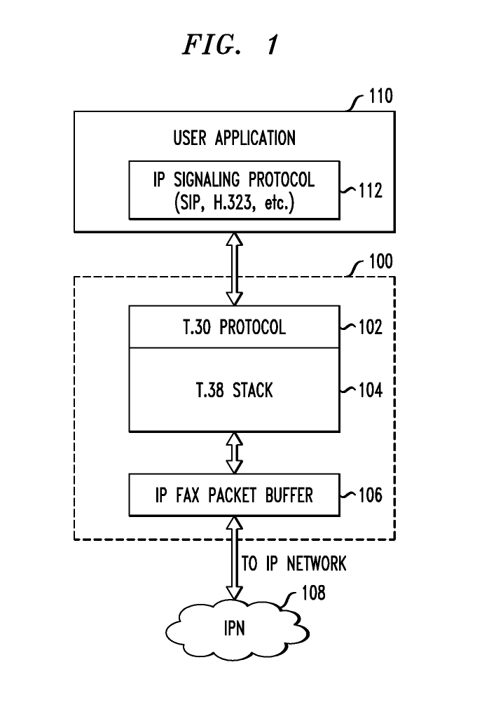

FIG. 1 is a block diagram depicting at least a portion of an illustrative dedicated IP-aware fax engine 100 adapted for providing fax communications over an IP network. The IP-aware fax engine 100, which may be implemented in an IP fax machine or other fax device, comprises a T.30 fax protocol stack 102 and a T.38 protocol stack 104 coupled to the T.30 fax protocol stack. Although depicted as separate functional units, it is to be appreciated that the T.30 fax protocol stack 102 and T.38 protocol stack may be integrated together within the same block, either alone or with other functional blocks (e.g., circuitry, software modules, etc.).

While not explicitly shown, the IP-aware fax engine 100 may further include a modem controller and fax data pump. Fax image data, representative of printed materials (e.g., text, photographs, or the like) to be transmitted, may be sent through the IP-aware fax engine 100, where they are properly formatted by the modem controller and modulated by the fax data pump for transmission via the IP network. In the IP network, an IP-based fax session may or may not require a modem controller and data pump, depending on the application employed.

The IP-aware fax engine 100 further comprises an IP fax packet buffer 106, or alternative buffer. Buffer 106 is operative to provide an interface between the IP-aware fax engine 100 and an IP network (IPN) 108. Buffer 106 is preferably operative to receive data packets from the T.38 protocol stack 104 and reformat them for transmission over the IP network 108. Likewise, packets received from the IP network 108 by the buffer 106 are preferably reformatted by the buffer for use by the T.38 protocol stack 104.

IP-aware fax engine 100 may be controlled by one or more user applications 110 via an IP signaling protocol unit 112, or an alternative interface/control block. IP signaling protocol unit 112 preferably interfaces with the IP-aware fax engine 100, and sets up fax calls using a known communications protocol, such as, for example, Session Initiation Protocol (SIP), ITU-T H.323 (see, e.g., ITU-T Recommendation H.323, Systems and terminal equipment for audiovisual services, Packet-based multimedia communications systems, SERIES H: AUDIOVISUAL AND MULTIMEDIA SYSTEMS, INFRASTRUCTURE OF AUDIOVISUAL SERVICES, December 2009, the disclosure of which is incorporated by reference herein in its entirety for all purposes), or an alternative control and/or signaling protocol. As previously stated, it is to be understood that the invention is not limited to use with any specific communications protocol(s).

The T.30 fax protocol stack 102 is operative to receive fax image data and/or control signals from, or transmit fax image data and/or controls signal to, user application 110. T.30 fax protocol stack 102 is preferably further operative to specify the procedures that a sending and receiving terminal use to set up a fax call, determine the image size, encoding, and transfer speed, the demarcation between pages, and/or the termination of the call, among other functions, according to the T.30 standard. The T.38 protocol stack 104 is operative to “fool” the terminal into thinking that it's communicating directly with another T.30 terminal. T.38 protocol stack 104, in conjunction with buffer 106, will also preferably correct for network delays with so-called spoofing techniques, and missing or delayed packets with fax-aware buffer-management techniques (e.g., store-and-forward processing).

There are two error correction schemes specified in the ITU-T T.38 standard; namely, (i) packet redundancy and (ii) forward error correction (FEC). These two schemes are intended to handle potential packet losses in the IP network which can often occur as a result of the nature of the IP network. While FEC is optional in the T.38 standard, the redundancy scheme is mandatory in the sense that all T.38 gateways must be able to decode the T.38 IP fax packet that uses the redundancy scheme. The term “gateway” as used herein is intended to broadly refer to a device, node or other functional unit operative in a communications network to interface with another network (or networks) which uses a different communications protocol(s). A gateway generally performs protocol translation/mapping for interconnecting networks with different network protocol topologies.

In practice, there are key disadvantages associated with existing error correction schemes. First, both error correction schemes (packet redundancy and FEC) substantially increase the bandwidth of a T.38/FoIP channel, which is undesirable. By way of example only, Group 3 fax transmissions, which conform to the ITU-T Recommendations T.30 and T.4 (see, e.g., ITU-T Recommendation T4, Standardization of Group 3 facsimile terminals for document transmission, SERIES T: TERMINALS FOR TELEMATIC SERVICES, July 2003, the disclosure of which is incorporated by reference herein in its entirety for all purposes), are digital formats that take advantage of digital compression schemes to greatly reduce transmission times. For G3 with V.34 modulation, also referred to as “Super G3” fax, with redundancy=3, the data bandwidth of T.38 traffic can be more than 134.4 kilobits per second (kbps) (i.e., 33.6 kbps×4), which is much higher than an ITU-T G.711 voice-band-data (VBD) channel (see, e.g., ITU-T Recommendation G.711, Pulse Code Modulation (PCM) of Voice Frequencies, General Aspects of Digital Transmission Systems, Terminal Equipments, November 1988, the disclosure of which is incorporated by reference herein in its entirety for all purposes), which transmits data at 64 kbps.

One touted advantage of T.38/FoIP is regarded to be its low bandwidth in comparison to other methodologies, such as, for example, a G.711 VBD channel. With standard error correction methods, however, the bandwidth advantage offered by T.38 is essentially negated.

Another disadvantage with the existing error correction schemes is that such existing schemes, even without consideration for the high cost of bandwidth, are generally ineffective at handling burst packet losses which are common in IP networks. With a redundancy scheme, if the packet redundancy is set to n (where n is typically a small number, e.g., less than 3 for data packets in most cases), only a maximum of n packets can be recovered during a burst packet loss. For example, consider the illustrative case where n=3 and 10 packets in a sequence are lost. In this scenario, only the last three lost packets can be recovered and the remaining seven packets will be lost. While n can be set higher to increase the number of packets that can be recovered during a burst packet loss (the T.38 specification does not impose a limit on n), there is a significant system resource and performance penalties for doing so. Hence, this approach is not sufficient for fax transmissions over an IP network which is susceptible to burst packet losses.

Accordingly, techniques of the present invention, in illustrative embodiments thereof, offer an alternative error correction methodology for fax transmissions over an IP network which is superior to conventional error correction approaches. Specifically, in the context of an exemplary T.38 FoIP session, aspects of the invention provide a retransmit-on-demand (ROD) methodology for recovering lost packets. As will be described in further detail below, an apparatus (e.g., fax receiver, etc.) operative to receive T.38 packets, or packets using an alternative communications protocol, requests retransmission of the lost (or potentially lost) packets based at least in part on received information. Because of the half-duplex nature of fax transmissions, an apparatus (e.g., fax transmitter, etc.) operative to transmit T.38 packets is adapted to send one or more newly devised frames (e.g., “keep-alive” or “idle” frames) periodically when data is not available from a data pump included in the fax apparatus or from the PSTN line.

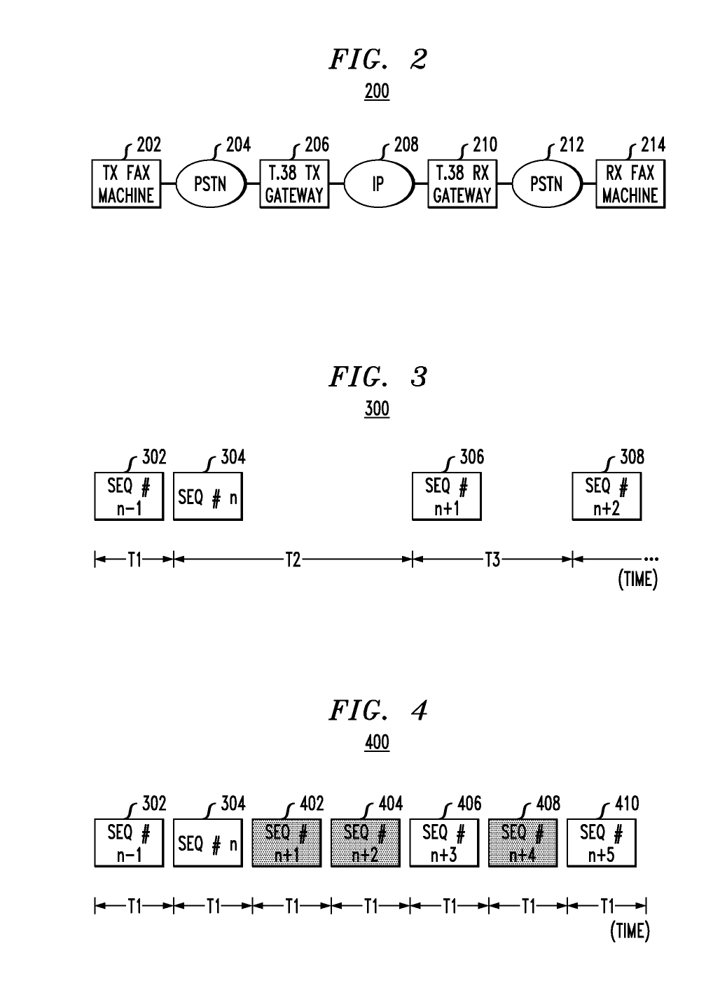

FIG. 2 is a block diagram depicting a simple exemplary FoIP network 200 in which principles of the present invention may be implemented. As apparent from the figure, network 200 preferably includes a transmit (Tx) fax machine 202 operatively coupled to a T.38 transmit gateway 206 through a first PSTN 204. The T.38 transmit gateway 206 is, in turn, operatively coupled to a T.38 receive (Rx) gateway 210 through an IP network 208. The T.38 receive gateway 210 is then operatively coupled to a receive fax machine 214 through a second PSTN 212. Transmit fax machine 202 may be implemented as a first fax terminal or other fax apparatus, configured in a transmit mode of operation. Similarly, Receive fax machine 214 may be implemented as a second fax terminal configured in a receive mode of operation. In other words, a fax terminal is typically capable of operation in either a transmit or a receive mode of operation at any given time.

T.38 essentially defines a protocol which supports the use of the T.30 protocol in both the transmit fax machine 202 (i.e., sender terminal) and the receive fax machine 214 (i.e., recipient terminal). T.38 transmit gateway 206 provides an interface between the PSTN 204 and IP network 208 preferably by modifying the T.30 protocol commands and information received from the transmit fax machine 202 on the PSTN side to keep network delays on the IP network side from causing the transaction to fail. This may be accomplished, for example, by padding image lines or deliberately causing a message to be re-transmitted to render network delays substantially transparent to the receiving fax machine 214. Similarly, the T.38 receive gateway 210 is operative to modify fax packets received from the IP network 208 and to deliver the fax packets to the receive fax machine 214 in a manner which ensures a relatively smooth flow of PSTN data upon their release. Thus, as previously stated, the T.38 protocol is operative to “fool” the fax terminal into thinking that it's communicating directly with another T.30 terminal.

As stated above, packet loss is very common in most IP networks. Missing packets will often cause a fax session to fail at worst or to generate one or more image lines in error at best. To insure the reliability of a T.38-based FoIP session, two standard packet recovery schemes have been introduced; namely, redundancy and forward error correction (FEC). These schemes not only increase data bandwidth, but are also not able to sufficiently handle burst packet losses. Techniques of the present invention, in accordance with embodiments thereof, advantageously provide an enhanced error correction methodology which addresses both of these problems.

According to an aspect of the invention, a retransmit-on-demand (ROD) methodology is provided in which a FoIP (e.g., T.38-capable) gateway/analog telephone adapter (ATA), for interfacing between an analog PSTN and an IP network (or alternative packet-based network), sends a retransmission request of one or more specified packets based at least in part on information that has been received and/or an elapsed time from a last received packet. The peer gateway/ATA preferably retransmits the packets, assuming the packets are still available, immediately upon receiving the request or within a prescribed time thereafter.

A fax transmission is, in most of cases, a half-duplex process. In a FoIP session, data transfer from one gateway to another is generally not continuous; that is, the time interval between IP fax packets can vary greatly depending upon a state of the session. With reference to FIG. 3, an illustrative sequence of packets in an exemplary fax transmission 300 is shown in which consecutive fax packets are transmitted having varying time intervals associated therewith. For example, a first fax packet 302 (packet n−1) is transmitted at time t, a second fax packet 304 (packet n) is transmitted at time t+T1, a third fax packet 306 (packet n+1) is transmitted at time t+T1+T2, a fourth fax packet 308 (packet n+2) is transmitted at time t+T1+T2+T3, and so on. As apparent from the figure, however, the time intervals T1, T2, and T3 are not equal relative to one another. Therefore, a receiver of the T.38 packets (e.g., receive fax machine 214 in FIG. 2) is not able to determine when a packet is lost since a large time gap/interval (e.g., greater than about 100 milliseconds (ms)) between packets may be normal in a T.30/T.38 FoIP session.

Because of this inherent inconsistency between the respective time intervals of consecutively transmitted fax packets 302, 304, 306, 308 in a given FoIP session (attributable at least in part to the nature of the IP network), two new types of packets are introduced in an error correction scheme according to an embodiment of the invention; namely, an “idle” packet and a “retransmit request” packet, as will be described in further detail below.

An idle packet, which may be implemented, for example, using a t30-indicator message in the context of a T.38 protocol, is employed to keep packet transmission from one gateway to another gateway in time intervals that are not greater than a prescribed (i.e., negotiated, for example, via signaling protocols such as, but not limited to, Session Initiation Protocol (SIP)/Session Description Protocol (SDP), H.248 or H.323) value. According to the Abstract Syntax Notation One (ASN.1) in Annex A of ITU-T T.38, Internet Fax Protocol (IFP) packets are essentially comprised of two fields. A first field is used to identify the type of IFP packet as either t30-indicator or t30-data. A second field, if required, contains payload data. t30-indicator messages are used to indicate when fax signals have been detected while t30-data messages are used to transfer blocks of data.

Note, that the “keep-alive” (or watchdog) function of the idle packets may sometimes be also performed by t30-indicator packets defined in T.38. For example, when a gateway first detects a V.17 carrier from the PSTN, it sends a v17 training indicator to its peer gateway. Because there is a training period (e.g., greater than about 500 ms) between the carrier detection and the receipt of the first byte of data, the gateway may send the idle packets in time intervals that are not greater than the prescribed (or negotiated) value. Alternatively, the gateway can also keep sending the v17 training indicator in the pre-defined (negotiated) time interval. A purpose of this keep-alive (or watchdog) scheme is to enable gateways to detect packet losses and to know when to request for retransmission of lost or potentially lost packets.

FIG. 4 is a block diagram depicting at least a portion of an exemplary fax transmission stream 400 in which one or more idle packets are inserted into the sequence of packets such that each packet interval is substantially the same relative to one another, according to an embodiment of the invention. Specifically, with reference again to FIG. 3, the time interval between the transmission of the first fax packet 302 (n−1) and the second fax packet 304 (n) is T1 (assuming that T1 is the pre-defined or negotiated maximum allowed packet interval). However, the time interval between transmission of the second fax packet 304 and the third fax packet 306 (n+1) is T2, with interval T2 being substantially greater than interval T1 (e.g., about three times greater). In this instance, the fax receiver may assume that a fax packet has been lost.

In order to address this problem, FIG. 4 shows the insertion of two idle packets, 402 (packet n+1) and 404 (packet n+2), between the second fax packet 304 and the third fax packet, reordered as fifth fax packet 406 (packet n+3), with the time interval between consecutive packets being less than or equal to T1. Likewise, in order to fill the time gap T3 between the transmission of fax packets 306 and 308 in FIG. 3, time interval T3 being greater than time interval T1, an idle packet 408 (packet n+4) is preferably inserted between the fifth fax packet 406 and the fourth fax packet 308 in FIG. 3, reordered as seventh fax packet 410 (packet n+5), with the time interval between consecutive packets being less than or equal to T1. Thus, idle packets will be sent (e.g., inserted into a fax transmission sequence by the transmit gateway 206 in FIG. 2) with valid sequence numbers periodically when there is no data available from the transmit fax apparatus or PSTN (e.g., 202 or 204, respectively, in FIG. 2). This enables a T.38 receive gateway/ATA (e.g., 210 in FIG. 2) to detect delay or loss of T.38 packets sent from the peer T.38 gateway/ATA (e.g., 206 in FIG. 2).

It is to be understood that the number of idle packets inserted between two otherwise consecutive fax data packets is not limited by the invention. Rather, the number of idle packets inserted into the sequence will be dependent upon the length of the time interval between transmitted fax data packets. For example, in the transmission of consecutive fax packets 304 and 406, since time interval T2 (shown in FIG. 3) is about three times greater than time interval T1, three packets total (including fax packet 304 and two idle packets 402 and 404) are inserted between the start of transmission of packet 304 and the start of transmission of packet 406. Conversely, in the transmission of consecutive fax packets 406 and 410, since time interval T3 (shown in FIG. 3) is only about twice T1, two packets total (including fax packet 406 and one idle packet 408) are inserted between the start of transmission of packet 406 and the start of transmission of packet 410. Furthermore, although the packets are preferably sent in substantially equal (e.g., fixed) time intervals T1, the invention is not limited to any specific value for the time intervals.

In contrast to an idle packet described above, a retransmit request packet is preferably operative to store sequence numbers of missing packets. The retransmit request packet may be implemented, for example, using a t30-data message in the context of a T.38 protocol. The sequence numbers of missing packets may be embedded in the payload data of the t30-data message. When a plurality of missed packets are detected that are consecutive in sequence number, only the sequence numbers of a start and an end of the missing packets need to be specified and stored. A retransmit request packet will preferably be sent when the receive gateway (e.g., 210 in FIG. 2) detects a loss, or potential loss, of one or more fax packets. In accordance with aspects of the invention, a user may control criteria for determining packet loss (or potential packet loss) and for sending retransmit request packets, for example in conjunction with jitter buffer management methodologies.

In one illustrative embodiment, requesting retransmission of a fax packet may be initiated by checking the sequence number of arriving packets, including idle packets, and sending out a retransmit request packet to the T.38 transmit gateway (e.g., 206 in FIG. 2) whenever a gap in the sequence number between consecutively received packets is detected. This methodology maybe performed, for example, in the T.38 receive gateway (e.g., 210 in FIG. 2). Alternatively, the methodology can be performed in other devices, such as, but not limited to, IP-aware fax machines and ATAs. The sequence number, or an alternative identifier by which a temporal sequence of a given data packet in a stream may be indicated, can be included, for example, in a header or a payload data portion of the packet, as will become apparent to those skilled in the art given the teachings herein. The receive fax apparatus (e.g., 214 in FIG. 2) may, alternatively, wait a prescribed period of time for out-of-order packets before sending the retransmit request packet to the transmit gateway.

A receiver of retransmit request packets (e.g., transmit gateway) will preferably check the availability of the requested packets and retransmit these packets immediately or within a prescribed period of time after receiving the retransmit request if the missed/requested packet is still available. Determining whether or not the requested/missing data packet(s) is(are) available for retransmission may involve, for example, comparing a first sequence identification (e.g., sequence number) of a data packet stored in the second gateway (e.g., in a transmit buffer) with a second sequence identification of an identified missing data packet. When the requested packet is no longer available, the gateway/ATA that receives the retransmit request packet may simply ignore the request.

The availability of the requested packets depends, at least in part, on a size of a transmit buffer, or other storage element, associated with the gateways and/or the time at which the retransmit request packet is received. The transmit buffer, which may be implemented, for example, using a circular buffer, stores previously transmitted packets. When a new packet is transmitted, a copy of the packet will preferably be stored in the transmit buffer for retransmission and error correction purposes, if necessary; in the meantime, the oldest packet in the transmit buffer will be pushed out or overwritten when all other storage locations in the buffer are filled. A gateway may inform the peer gateway of its transmit buffer size, for example, during call setup via signaling protocols (e.g., SIP/SDP, H.248, H.323, etc), or by alternative means. When the gateway sending a retransmit request does not receive the retransmitted packets within a prescribed period of time, it may assume that the packets are not recoverable and proceed to process the next available packets.

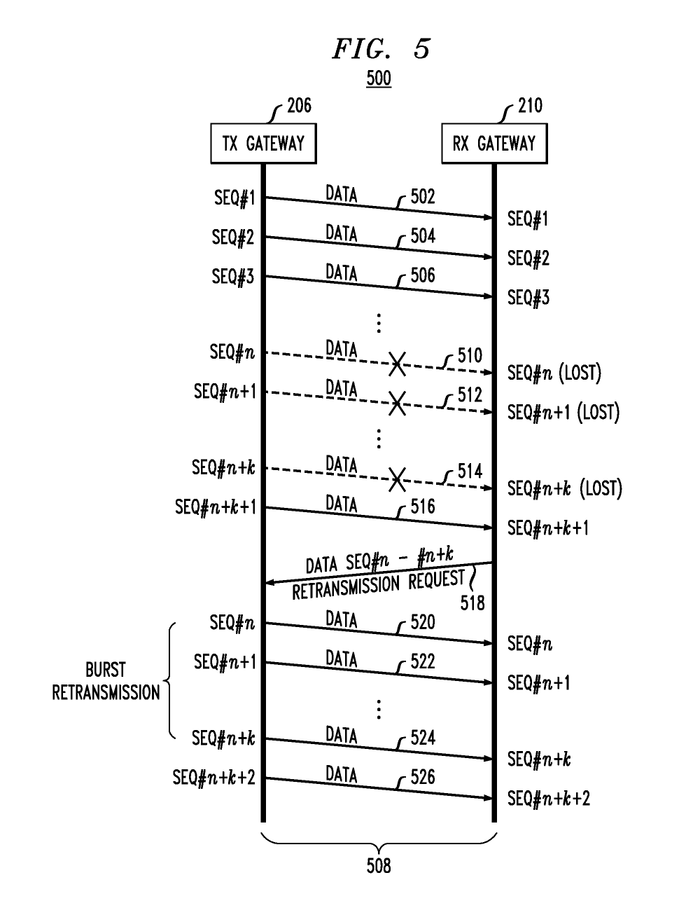

By way of example only and without loss of generality, FIG. 5 depicts at least a portion of an illustrative data transfer 500 between a transmit gateway 206 and a receive gateway 210 during a FoIP session, according to an embodiment of the invention. As apparent from the figure, at least the first three data packets, with sequence numbers Seq#1 through Seq#3, sent by the transmit gateway 206 are received by the receive gateway 210 in the proper order, as indicated by arrows 502, 504 and 506. However, data packets with sequence number from n to n+k transmitted by transmit gateway 206 are lost due to some error (e.g., burst error) attributable to, for example, the transmit gateway 206, the receive gateway 210, and/or the communications channel 508 established between the transmit and receive gateways, as indicated by dotted arrows 510 through 514. The next data packet actually received by the receive gateway 210 is the data packet with sequence number n+k+1, which is assumed to be non-consecutive in relation to the data packet with sequence number Seq#3, as indicated by arrow 516.

The receive gateway 210 detects the packet loss and, after storing (e.g., in memory associated with the receive gateway) the data packet with sequence number n+k+1, sends a retransmission request for the lost packets, as indicated by arrow 518. The retransmission request preferably includes the sequence number of the lost data packet (or sequence numbers if multiple lost data packets are detected). Assuming a copy of the requested packets are still available, transmit gateway 206 will retransmit the requested lost packets, preferably in a burst mode in order to recover the packets in a shorter period of time. In burst mode, a plurality of requested data packets, as identified in the retransmission request, are sent in relatively quick succession compared to a normal transfer rate of the fax data packets. Retransmission of the requested data packets is indicated by arrows 520 through 524.

If the retransmitted packets are still not received by the receive gateway 210 within a prescribed period of time (and are thus presumed lost), another retransmission request may be sent by the receive gateway 210 to the transmit gateway 206. A limit to the number of retransmission attempts may be set by a user (e.g., maximum of two retransmission attempts); otherwise, packet retransmission may interfere with the normal transmission of packet sequences by the transmit gateway 206. Alternatively, if the retransmitted packets are not received, an error message may be sent by the receive gateway 210 or the lost data packets may be simply ignored, at which processing continues with the next received packet.

Once retransmission of the missing data packets is complete (either successfully or unsuccessfully), the transmit gateway 206 preferably resumes normal transmission of the data packets using the next sequence number, n+k+2, following the sequence number of the last data packet that was successfully received (e.g., Seq#n+k+1), as indicated by arrow 526.

In certain instances in which packets are sent out in a substantially regular time interval, the insertion of idle packets into the packet stream may not be required during image data transfer. Moreover, it is possible to apply this error correction scheme only for the image data transfer mode (e.g., Phase C—image transfer and message transmission—of a T.30 fax session), according to embodiments of the invention. In this case, idle packets are not required.

As previously stated, error correction techniques according to the invention may be combined with one or more known error correction schemes (e.g., redundancy and/or FEC, in the context of a T.38 protocol) to obtain further advantages during a given FoIP session. For example, one can employ both redundancy error correction and ROD in a T.38-based FoIP session, in accordance with an aspect of the invention.

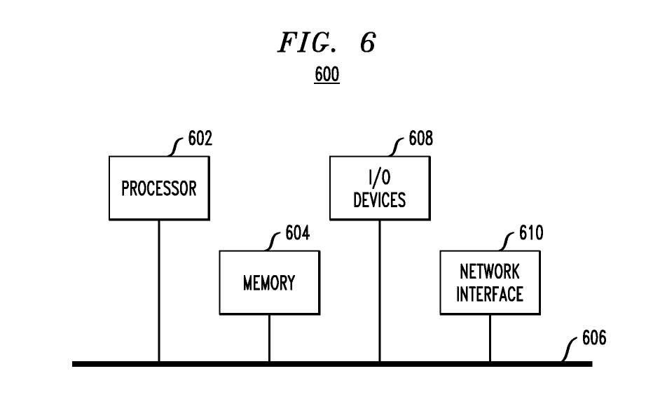

Methodologies of embodiments of the present invention may be particularly well-suited for implementation in an electronic device or alternative system, such as, for example, a network-capable fax device, fax communications system, etc. By way of illustration only, FIG. 6 is a block diagram depicting an exemplary data processing system 600, formed in accordance with an aspect of the invention. System 600 may represent, for example, a fax device (e.g., fax modem, fax machine, etc.) adapted for communicating with a PC and/or another fax device using, for example, a G3 and/or a T.38 communications protocol. System 600 may include a processor 602, memory 604 coupled to the processor, as well as input/output (I/O) circuitry 608 operative to interface with the processor. The processor 602, memory 604, and I/O circuitry 608 can be interconnected, for example, via a bus 606, or alternative connection means, as part of data processing system 600. Suitable interconnections, for example via the bus, can also be provided to a network interface 610, such as a network interface card (NIC), which can be provided to interface with a computer or IP network, and to a media interface, such as a diskette or CD-ROM drive, which can be provided to interface with media. The processor 602 may be configured to perform at least a portion of the methodologies of the present invention described herein above.

It is to be appreciated that the term “processor” as used herein is intended to include any processing device, such as, for example, one that includes a central processing unit (CPU) and/or other processing circuitry (e.g., network processor, DSP, microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, one or more output devices (e.g., printer, monitor, etc.) for presenting the results associated with the processor, and/or interface circuitry for operatively coupling the input or output device(s) to the processor.

Accordingly, an application program, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 602. In any case, it is to be appreciated that at least a portion of the components shown in FIGS. 1 and 2 may be implemented in various forms of hardware, software, or combinations thereof, e.g., one or more DSPs with associated memory, application-specific integrated circuit(s), functional circuitry, one or more operatively programmed general purpose digital computers with associated memory, etc. Given the teachings of the invention provided herein, one of ordinary skill in the art will be able to contemplate other implementations of the components of the invention.

At least a portion of the techniques of the present invention may be implemented in one or more integrated circuits. In forming integrated circuits, die are typically fabricated in a repeated pattern on a surface of a semiconductor wafer. Each of the die includes a memory described herein, and may include other structures or circuits. Individual die are cut or diced from the wafer, then packaged as integrated circuits. One skilled in the art would know how to dice wafers and package die to produce integrated circuits. Integrated circuits so manufactured are considered part of this invention.

An IC in accordance with embodiments of the present invention can be employed in any application and/or electronic system which is adapted for providing fax communications (e.g., fax modem/machine). Suitable systems for implementing embodiments of the invention may include, but are not limited to, personal computers, portable communications devices (e.g., cell phones), fax devices, etc. Systems incorporating such integrated circuits are considered part of this invention. Given the teachings of the invention provided herein, one of ordinary skill in the art will be able to contemplate other implementations and applications of the techniques of the invention.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method for correcting at least one error in a facsimile transmission over a packet switched communications network, the method comprising the steps of:
detecting, by a first gateway coupled to the communications network, at least one missing data packet in a sequence of data packets transmitted from a second gateway coupled to the communications network during the facsimile transmission;
transmitting, from the first gateway, a request for retransmission of the at least one missing data packet to the second gateway;
determining whether the at least one missing data packet is available for retransmission; and
when the at least one missing data packet is available, retransmitting the at least one missing data packet to the first gateway.

2. The method of claim 1, wherein the step of detecting the at least one missing data packet comprises:
comparing a first sequence identification corresponding to a present received data packet with a second sequence identification corresponding to a next previously received data packet; and
when the first and second sequence identifications are not consecutive, generating the request for retransmission.

3. The method of claim 2, wherein the step of generating the request for retransmission comprises:
storing a sequence identification of the at least one data packet in the sequence of data packets determined to be missing; and
transmitting the sequence identification of the at least one data packet determined to be missing with the request for retransmission.

4. The method of claim 1, further comprising:
determining a time interval between consecutively received data packets in the sequence of data packets; and
when the time interval between a start of one data packet and a start of a next subsequent data packet is greater than a prescribed value, inserting at least one idle packet in the sequence of data packets transmitted from the second gateway.

5. The method of claim 4, wherein the step of inserting at least one idle packet in the sequence of data packets comprises:
assigning the at least one idle packet a first sequence identification indicating the at least one idle packet as a next subsequent packet in the sequence of data packets; and
assigning the next subsequent data packet a second sequence identification indicating the next subsequent data packet as being temporally subsequent to the at least one idle packet inserted in the sequence of data packets.

6. The method of claim 4, wherein at least one of a number and a duration of idle packets inserted between two consecutive data packets in the sequence of data packets is a controlled such that a time interval between any two consecutively transmitted packets is less than or equal to a prescribed value.

7. The method of claim 4, wherein the facsimile transmission implements an ITU T.38 facsimile communications protocol and the at least one idle packet comprises a t30-indicator message, in a context of the T.38 protocol, for controlling packet transmission from one gateway to another gateway so that time intervals between consecutively transmitted packets are less than or equal to a prescribed value.

8. The method of claim 1, wherein the step of determining whether the at least one missing data packet is available for retransmission comprises comparing a first sequence identification of a data packet stored in the second gateway with a second sequence identification of the at least one missing data packet.

9. The method of claim 1, further comprising, for a given data packet transmitted from the second gateway, storing a copy of the given data packet in the second gateway.

10. The method of claim 1, wherein the step of retransmitting the at least one missing data packet comprises, when a plurality of missing data packets are detected, transmitting the missing data packets in a burst mode.

11. The method of claim 1, wherein the second gateway, in response to the request for retransmission, retransmits the at least one missing data packet immediately upon receiving the request for retransmission.

12. The method of claim 1, wherein the second gateway, in response to the request for retransmission, retransmits the at least one missing data packet within a prescribed time after receiving the request for retransmission.

13. The method of claim 1, further comprising sending, to the first gateway, a size of a transmit buffer associated with the second gateway, the transmit buffer being operative to store a copy of at least one data packet transmitted to the first gateway, a number of data packets available for retransmission being a function of the size of the transmit buffer.

14. The method of claim 1, further comprising designating the at least one missing data packet as being unavailable for retransmission when the first gateway does not receive the at least one missing data packet retransmitted by the second gateway within a prescribed period of time.

15. The method of claim 1, further comprising, when the at least one missing data packet is determined to be unavailable for retransmission, ignoring the request for retransmission.

16. The method of claim 1, further comprising, when the retransmitted at least one missing data packet is not received by the first gateway, sending at least a second request for retransmission of the at least one missing data packet to the second gateway.

17. The method of claim 16, further comprising setting a maximum number of retransmission requests sent by the first gateway to a prescribed value.

18. The method of claim 1, wherein an ITU T.38 facsimile communications protocol is implemented for transmitting data packets during the facsimile transmission.

19. An apparatus for correcting at least one error in a facsimile transmission over a packet switched communications network, the apparatus comprising:
at least a first gateway adapted for connection to the packet switched communications network, the at least first gateway including at least one processor operative: (i) to detect at least one missing data packet in a sequence of data packets transmitted from a second gateway coupled to the communications network during the facsimile transmission; (ii) to transmit a request for retransmission of the at least one missing data packet to the second gateway; and (iii) to receive the at least one missing data packet retransmitted from the second gateway when the at least one missing data packet is available for retransmission.

20. An apparatus for correcting at least one error in a facsimile transmission over a packet switched communications network, the apparatus comprising:
at least a first gateway adapted for connection to the packet switched communications network, the at least first gateway including memory and at least one processor coupled to the memory, the at least one processor being operative: (i) to transmit at least one facsimile data packet in a sequence of data packets to a second gateway coupled to the communications network during the facsimile transmission; (ii) to store, in the memory, a copy of the at least one data packet; (iii) to receive a request for retransmission of at least one missing data packet, the request for retransmission being sent by the second gateway and identifying the at least one missing data packet in the sequence of data packets detected by the second gateway; (iv) to retransmit the at least one missing data packet to the second gateway when the at least one missing data packet is available in the memory for retransmission.

21. The apparatus of claim 20, wherein the at least one processor is further operative: (v) to determine a time interval between consecutively transmitted data packets in the sequence of data packets; and (vi) when the time interval between a start of one data packet and a start of a next subsequent data packet is greater than a prescribed value, to insert at least one idle packet in the sequence of data packets transmitted from the first gateway.
